(19) United States
(12) Patent Application Publication
(10) Pub. No.: US 2018/0050566 A1
(43) Pub. Date: Feb. 22, 2018

(54) TIRE COMPRISING A COMPOSITION COMPRISING A DERIVATIVE OF ZINC DIACRYLATE AND A PEROXIDE

(71) Applicant: COMPAGNIE GENERALE DES ETABLISSEMENTS MICHELIN, CLERMONT-FERRAND (FR)

(72) Inventors: DIDIER VASSEUR, Clermont-Ferrand (FR); AURORE CROCHET, Clermont-Ferrand (FR)

(21) Appl. No.: 15/555,736

(22) PCT Filed: Mar. 3, 2016
(86) PCT No.: PCT/EP2016/054494

§ 371 Date: Sep. 5, 2017

(30) Foreign Application Priority Data
Mar. 5, 2015 (FR) 1551846

(51) Int. Cl. B60C 1/00; C08L 9/00; C08K 3/04; C08K 5/098; C08K 5/14

(52) U.S. Cl. CPC B60C 1/0041; C08L 9/00; C08K 3/04; B60C 2001/0066; C08K 5/14; B60C 2001/005; C08K 5/098

(57) ABSTRACT

A tire is provided with an internal layer, said internal layer comprising a rubber composition based on at least one diene elastomer, a zinc diacrylate derivative in the form of a zinc salt wherein R₁, R₂ and R₃ independently represent a hydrogen atom or a C₁-C₇ hydrocarbon group selected from linear, branched or cyclic alkyl groups, aralkyl groups, alkylaryl groups and aryl groups and optionally interrupted by one or more heteroatoms, it being possible for R₂ and R₃ to together form a nonaromatic ring, said composition additionally comprising a peroxide. The contents of zinc diacrylate derivative and of peroxide are such that the ratio of the content of peroxide to the content of zinc diacrylate derivative is less than or equal to 0.09, said composition not comprising a reinforcing filler or comprising less than 65 phr thereof, the ratio of the content of filler to the content of zinc diacrylate derivative being less than or equal to 4.

### FIELD OF THE INVENTION

The invention relates to tyres and more particularly to those for which the composition of an internal layer comprises a zinc diacrylate derivative and a peroxide.

### RELATED ART

Such compositions are described in some documents of the state of the art for objects which are not internal layers of tyres. For example, the document US 2003/0065076 describes compositions for military tank tracks comprising an elastomer, a reinforcing filler, zinc diacrylate or zinc dimethacrylate, and a peroxide, with the effect of an improvement in the abrasion resistance. In this document, the ratio of the content of peroxide, on the one hand, to the content of zinc diacrylate or zinc dimethacrylate, on the other hand, has a value of 0.1, 0.12 or 0.15 according to the examples.

Likewise, the document US 2005/0084638 describes compositions of mixtures for covering an air sleeve for suspensions, also comprising an elastomer, a reinforcing filler, zinc diacrylate and a peroxide. In this document, the ratio of the content of peroxide to the content of zinc diacrylate has a value of 0.15 or 0.2 according to the examples.

In the specific field of tyres and more particularly their internal layers, since fuel savings and the need to protect the environment have become a priority, it has proved necessary to produce tyres having a reduced rolling resistance, without adversely affecting the other properties of the tyre. Furthermore, the mixtures of the tyres are sensitive to ageing, this ageing depending on multiple factors and in particular on the use and on the region in the tyre. The internal layer mixtures are generally subjected to severer thermal conditions than the external mixtures, which are cooled by the external air. This ageing impacts the properties of the material, as described in two publications of 1990 (Asahiro Ahagon, M. Kida and H. Kaidou, Aging of Tire Parts during Service. I. Types of Aging in Heavy-Duty Tires, Rubber Chemistry and Technology: November 1990, Vol. 63, No. 5, pp. 683-697, and Hiroyuki Kaidou and A. Ahagon, Aging of Tire Parts during Service. II. Aging of Belt-Skim Rubbers in Passenger Tires, Rubber Chemistry and Technology: November 1990, Vol. 63, No. 5, pp. 698-712), with the consequence of an increase in hysteresis and thus an increase in the rolling resistance. Manufacturers have developed tyre compositions which make it possible to reduce this rolling resistance, in various ways and in particular by the introduction of silica into the mixtures as reinforcing filler.

Nevertheless, manufacturers are always looking for solutions for further lowering the rolling resistance of tyres and it is in this context that the applicant companies have discovered, surprisingly, that the hysteresis can be markedly decreased in rubber compositions for tyres, with a reduced content of reinforcing filler, the composition comprising a zinc diacrylate derivative and a peroxide, provided that a suitable ratio of the content of peroxide to the content of zinc diacrylate derivative is adopted.

Furthermore, this solution exhibits numerous other advantages in comparison with the compositions of the prior art and in particular an improved resistance to ageing under thermal and thermal/oxidizing conditions, which are the two ageing conditions which the internal layer mixtures may be subjected to during the use of the tyre.

### BRIEF DESCRIPTION OF EMBODIMENTS OF THE INVENTION

The invention thus relates to a tyre provided with an internal layer comprising a rubber composition based on at least one diene elastomer, a zinc diacrylate derivative in the form of a zinc salt of formula (I):

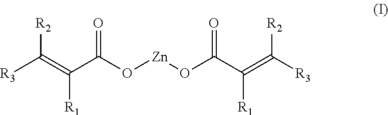

wherein R₁, R₂ and R₃ independently represent a hydrogen atom or a C₁-C₇ hydrocarbon group selected from linear, branched or cyclic alkyl groups, aralkyl groups, alkylaryl groups and aryl groups and optionally interrupted by one or more heteroatoms, it being possible for R₂ and R₃ to together form a nonaromatic ring, said composition additionally comprising a peroxide, the contents of zinc diacrylate derivative and of peroxide being such that the ratio of the content of peroxide to the content of zinc diacrylate derivative is less than or equal to 0.09, said composition not comprising a reinforcing filler or comprising less than 65 phr thereof, the ratio of the content of filler to the content of zinc diacrylate derivative being less than or equal to 4.

Preferably, the invention relates to a tyre as defined above wherein R₁, R₂ and R₃ independently represent a hydrogen atom or a methyl group. More preferably, R₂ and R₃ each represent a hydrogen atom. More preferably again, R₁ represents a methyl group.

Preferably, the invention relates to a tyre as defined above wherein the amount of zinc diacrylate derivative in the composition is within a range extending from 5 to 40 phr (parts by weight per hundred parts by weight of elastomer), preferably from 7 to 35 phr.

Preferably, the invention relates to a tyre as defined above wherein the peroxide in the composition is an organic peroxide, preferably present in an amount of less than or equal to 3 phr. More preferably, the amount of peroxide in the composition is within a range extending from 0.1 to 3 phr, more preferably from 0.2 to 2.5 phr and more preferably still from 0.25 to 1.8 phr.

Preferably, the invention relates to a tyre as defined above wherein the ratio of the content of peroxide to the content of zinc diacrylate derivative is between 0.01 and 0.09, preferably between 0.03 and 0.09 and more preferably between 0.05 and 0.08.

Preferably, the invention relates to a tyre as defined above wherein the diene elastomer is selected from the group consisting of polybutadienes, synthetic polyisoprenes, natural rubber, butadiene copolymers, isoprene copolymers and the mixtures of these elastomers. More preferably, the diene elastomer is selected from the group consisting of isoprene elastomers, and preferably from the group consisting of natural rubber, synthetic polyisoprenes, the various isoprene copolymers and the mixtures of these elastomers.

Preferably, the invention relates to a tyre as defined above wherein the content of reinforcing filler is within a range extending from 5 to 60 phr, more preferably from 10 to 50 phr, better still from 20 to 40 phr.

Preferably, the invention relates to a tyre as defined above wherein the reinforcing filler is carbon black, silica or a mixture of the latter. Preferably, the reinforcing filler is predominantly composed of carbon black.

Preferably, the invention relates to a tyre as defined above wherein the ratio of the content of filler to the content of zinc diacrylate derivative is within a range extending from 0.15 to 3, preferably from 1.5 to 3, alternatively and also preferably from 0.7 to 1.3.

Preferably, the invention relates to a tyre as defined above wherein the composition does not contain molecular sulphur or a sulphur-donating agent as vulcanization agent or contains less than 0.5 phr thereof. Preferably, the composition does not contain molecular sulphur or a sulphur-donating agent as vulcanization agent or contains less than 0.3 phr and preferably less than 0.1 phr thereof. Preferably, the composition does not contain a vulcanization accelerator.

Preferably, the invention relates to a tyre as defined above wherein the composition does not contain an antioxidant.

Preferably again, the invention relates to a tyre as defined above wherein the composition additionally comprises a plasticizer preferably chosen from plasticizing resins, extending oils and their mixtures.

Preferably, the tyre according to the invention will be chosen from the tyres intended to equip a two-wheel vehicle, a passenger vehicle, or also a “heavy-duty” vehicle (that is to say, underground, bus, off-road vehicles, heavy road transport vehicles, such as lorries, tractors or trailers), or also aircraft, construction equipment, heavy agricultural vehicles or handling vehicles.

### DETAILED DESCRIPTION OF THE INVENTION

### I—Constituents of the Composition of the Internal Layer

The rubber composition of the internal layer of the tyre according to the invention is based on the following constituents: a zinc diacrylate derivative in the form of a zinc salt of formula (I) and a peroxide, the contents of zinc diacrylate derivative and of peroxide being such that the ratio of the content of peroxide to the content of zinc diacrylate derivative is less than or equal to 0.09, said composition not comprising a reinforcing filler or comprising less than 65 phr thereof, the ratio of the content of filler to the content of zinc diacrylate derivative being less than or equal to 4.

In the present patent application, the expression “phr” means, in a known way, parts by weight per hundred parts by weight of elastomer. The amount by weight of the constituents of the compositions is thus expressed with respect to the total amount of elastomers by weight conventionally considered at the hundred value.

The expression “composition based on” should be understood as meaning a composition comprising the mixture and/or the product of the in situ reaction of the various base constituents used, some of these constituents being able to react and/or being intended to react with one another, at least partially, during the various phases of manufacture of the composition or during the subsequent curing, modifying the composition as it is prepared at the start. Thus, the compositions as employed for the invention can be different in the non-crosslinked state and in the crosslinked state.

In the present description, unless expressly indicated otherwise, all the percentages (%) shown are percentages by weight. Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

Within the meaning of the present invention and in a way known to a person skilled in the art, internal layer of the tyre is understood to mean any layer of the tyre which is not in contact with the ambient air or the inflation gas of the tyre. This is because it is possible to define, within the tyre, three types of regions:
The internal region of the tyre, that is to say that between the exterior and interior regions. This region includes layers or plies which are referred to here as “internal layers” of the tyre. These are, for example, carcass plies, tyre belt plies or any other layer which is not in contact with the ambient air or the inflation gas of the tyre. According to the invention, the internal layer can be selected from the group consisting of carcass plies, crown plies, bead-wire fillings, decoupling layers (layers intended to ensure the connection or interface between the abovementioned layers of the tyres) and a combination of these internal layers, preferably from the group consisting of carcass plies, crown plies, bead-wire fillings and a combination of these internal layers.
The radially interior region in contact with the inflation gas, this region generally being composed of the layer airtight to the inflation gases, sometimes known as inner liner.
The radially exterior region in contact with the ambient air, this region being essentially composed of the tread and of the external sidewall of the tyre. The tread of the tyre is positioned radially above the tyre belt and thus constitutes the layer in contact with the running surface.

### I-1 Diene Elastomer

The internal layer compositions of the tyre of the invention can contain just one diene elastomer or a mixture of several diene elastomers.

It is recalled here that elastomer (or “rubber”, the two terms being regarded as synonymous) of the “diene” type should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

Diene elastomers can be classified into two categories: “essentially unsaturated” or “essentially saturated”. “Essentially unsaturated” is generally understood to mean a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content, always less than 15%, of units of diene origin). In the category of “essentially unsaturated” diene elastomers, “highly unsaturated” diene elastomer is understood in particular to mean a diene elastomer having a content of units of diene origin (conjugated dienes) which is greater than 50%.

Given these definitions, diene elastomer capable of being used in the internal layer compositions according to the invention is understood more particularly to mean:
(a) any homopolymer obtained by polymerization of a conjugated diene monomer having from 4 to 12 carbon atoms;
(b) any copolymer obtained by copolymerization of one or more conjugated dienes with one another or with one or more vinylaromatic compounds having from 8 to 20 carbon atoms;
(c) a ternary copolymer obtained by copolymerization of ethylene and of an α-olefin having from 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d) a copolymer of isobutene and of isoprene (butyl rubber) and also the halogenated versions, in particular chlorinated or brominated versions, of this type of copolymer.

Although it applies to any type of diene elastomer, a person skilled in the art of tyres will understand that the present invention is preferably employed with essentially unsaturated diene elastomers, in particular of the above type (a) or (b).

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene. The copolymers can contain between 99% and 20% by weight of diene units and between 1% and 80% by weight of vinylaromatic units. The elastomers can have any microstructure which depends on the polymerization conditions used, in particular on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalization agent. Mention may be made, for example, for coupling to carbon black, of functional groups comprising a C—Sn bond or aminated functional groups, such as aminobenzophenone, for example; mention may be made, for example, for coupling to a reinforcing inorganic filler, such as silica, of silanol or polysiloxane functional groups having a silanol end (such as described, for example, in FR 2 740 778, U.S. Pat. No. 6,013,718 and WO 2008/141702), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909, U.S. Pat. No. 6,503,973, WO 2009/000750 and WO 2009/000752). Mention may also be made, as other examples of functionalized elastomers, of elastomers (such as SBR, BR, NR or IR) of the epoxidized type.

To summarize, the diene elastomer of the composition is preferentially selected from the group of highly unsaturated diene elastomers consisting of polybutadienes (abbreviated to “BRs”), synthetic polyisoprenes (IRs), natural rubber (NR), butadiene copolymers, isoprene copolymers and the mixtures of these elastomers. Such copolymers are more preferentially selected from the group consisting of butadiene/styrene copolymers (SBRs), isoprene/butadiene copolymers (BIRs), isoprene/styrene copolymers (SIRs), isoprene/butadiene/styrene copolymers (SBIRs), butadiene/acrylonitrile copolymers (NBRs), butadiene/styrene/acrylonitrile copolymers (NSBRs) or a mixture of two or more of these compounds.

According to a particularly preferred embodiment, the diene elastomer is a predominantly isoprene elastomer (that is to say, the fraction by weight of isoprene elastomer of which is the greatest, compared with the fraction by weight of the other elastomers). “Isoprene elastomer” is understood to mean, in a known way, an isoprene homopolymer or copolymer, in other words a diene elastomer selected from the group consisting of natural rubber (NR), which may be plasticized or peptized, synthetic polyisoprenes (IR), various isoprene copolymers and the mixtures of these elastomers. Mention will in particular be made, among isoprene copolymers, of isobutene/isoprene (butyl rubber IIR), isoprene/styrene (SIR), isoprene/butadiene (BIR) or isoprene/butadiene/styrene (SBIR) copolymers. This isoprene elastomer is preferably natural rubber or a synthetic cis-1,4-polyisoprene; use is preferably made, among these synthetic polyisoprenes, of polyisoprenes having a content (mol %) of cis-1,4-bonds of greater than 90%, more preferably still of greater than 98%. Preferably, according to this embodiment, the content of isoprene diene elastomer is of more than 50 phr (that is to say, from 50 to 100 phr), more preferably of at least 60 phr (that is to say, from 60 to 100 phr), more preferably of at least 70 phr (that is to say, from 70 to 100 phr), more preferably still of at least 80 phr (that is to say, from 80 to 100 phr) and very preferably of at least 90 phr (that is to say, from 90 to 100 phr). In particular, according to this embodiment, the content of isoprene diene elastomer is very preferably 100 phr.

### I-2 Zinc Diacrylate Derivative

The tyre according to the invention is provided with an internal layer which comprises a composition which comprises a zinc diacrylate derivative in the form of a zinc salt of formula (I):

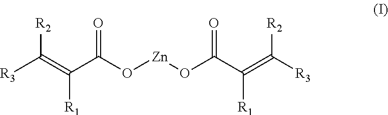

wherein R₁, R₂ and R₃ independently represent a hydrogen atom or a C₁-C₇ hydrocarbon group selected from linear, branched or cyclic alkyl groups, aralkyl groups, alkylaryl groups and aryl groups and optionally interrupted by one or more heteroatoms, it being possible for R₂ and R₃ to together form a nonaromatic ring.

Cyclic alkyl group is understood to mean an alkyl group comprising one or more rings.

Hydrocarbon group or chain interrupted by one or more heteroatoms is understood to mean a group or chain comprising one or more heteroatoms, each heteroatom being between two carbon atoms of said group or said chain or between a carbon atom of said group or said chain and another heteroatom of said group or said chain or between two other heteroatoms of said group or said chain.

The heteroatom or heteroatoms can be a nitrogen, sulphur or oxygen atom.

Preferably, R₁, R₂ and R₃ independently represent a hydrogen atom or a methyl group. More preferably, R₂ and R₃ each represent a hydrogen atom and, according to an also very preferred alternative, R₁ represents a methyl group.

In the composition of the internal layer of the tyre according to the invention, the amount of zinc diacrylate derivative is preferably within a range extending from 10 to 50 phr, preferably from 20 to 30 phr. Above a content of 50 phr, the dispersion is poorer and the properties of the composition may deteriorate, whereas, below a content of 10 phr, the effect of the zinc diacrylate derivative is less noteworthy with regard to the stiffening and the reinforcing.

By way of example, zinc diacrylate derivatives, such as zinc diacrylate (ZDA) “Dimalink 633” from Cray Valley or zinc dimethacrylate (ZDMA) “Dimalink 634” from Cray Valley, are available commercially.

### I-3 Peroxide

In addition to the diene elastomer and the zinc diacrylate derivative which are described above, the composition of the internal layer of the tyre of the invention uses a peroxide, which can be any peroxide known to a person skilled in the art.

Among the peroxides well known to a person skilled in the art, it is preferable to use, for the invention, a peroxide chosen from the family of the organic peroxides and in particular a peroxide chosen from dicumyl peroxide, aryl or diaryl peroxides, diacetyl peroxide, benzoyl peroxide, dibenzoyl peroxide, di(tert-butyl) peroxide, tert-butyl cumyl peroxide, 2,5-bis(tert-butylperoxy)-2,5-dimethylhexane and the mixtures of these.

Various packaged products, known under their trade names, are available commercially; mention may be made of Dicup from Hercules Powder Co., Perkadox Y12 from Noury van der Lande, Peroximon F40 from Montecatini Edison S.p.A., Trigonox from Noury van der Lande, Varox from R.T.Vanderbilt Co. or else Luperko from Wallace & Tiernan Inc.

Preferably, the amount of peroxide to be used for the requirements of the invention is less than or equal to 3 phr. Preferably, the amount of peroxide in the composition is within a range extending from 0.1 to 3 phr. This is because, below an amount of 0.1 phr, the effect of the peroxide is not noteworthy, whereas, above 3 phr, the elongation at break and thus the strength properties of the composition are weakened. More preferably, the amount of peroxide in the composition is within a range extending from 0.2 to 2.5 phr, preferably from 0.25 to 1.8 phr.

Whatever the amounts of zinc diacrylate derivative and of peroxide seen above, it is important for the invention for the ratio of the content of peroxide to the content of zinc diacrylate derivative to be less than or equal to 0.09. Above such a content, the synergy between the zinc diacrylate derivative and the peroxide is not as effective in terms of effect on the rheometry and on the elongation at break, in particular for a composition subjected to the stresses of a tyre internal layer. Preferably, the ratio of the content of peroxide to the content of zinc diacrylate derivative is between 0.01 and 0.09, preferably between 0.03 and 0.09 and more preferably between 0.05 and 0.08.

### I-4 Reinforcing Filler

The diene elastomer, the zinc diacrylate derivative and the peroxide are sufficient by themselves alone for the invention to be carried out. Nevertheless, the composition of the internal layer of the tyre according to the invention can comprise a reinforcing filler.

The physical state under which the reinforcing filler is provided is not important, whether it is in the form of a powder, of microbeads, of granules, of beads or any other appropriate densified form.

Use may be made of any type of reinforcing filler known for its abilities to reinforce a rubber composition which can be used in the manufacture of tyres, for example an organic filler, such as carbon black, a reinforcing inorganic filler, such as silica, or also a blend of these two types of filler.

All carbon blacks, in particular “tyre-grade” blacks, are suitable as carbon blacks. Mention will more particularly be made, among the latter, of the reinforcing carbon blacks of the 100, 200 or 300 series (ASTM grades), such as, for example, the N115, N134, N234, N326, N330, N339, N347 or N375 blacks, or else, depending on the applications targeted, the blacks of higher series (for example N660, N683 or N772). The carbon blacks might, for example, be already incorporated in an isoprene elastomer in the form of a masterbatch (see, for example, Applications WO 97/36724 or WO 99/16600).

Mention may be made, as examples of organic fillers other than carbon blacks, of functionalized polyvinyl organic fillers, such as described in Applications WO-A-2006/069792, WO-A-2006/069793, WO-A-2008/003434 and WO-A-2008/003435.

The composition can also contain one type of silica or a blend of several silicas. The silica used can be any reinforcing silica known to a person skilled in the art, in particular any precipitated or fumed silica exhibiting a BET specific surface and a CTAB specific surface which are both less than 450 m²/g, preferably from 30 to 400 m²/g. Mention will be made, as highly dispersible precipitated silicas (“HDSs”), for example, of the Ultrasil 7000 and Ultrasil 7005 silicas from Degussa, the Zeosil 1165MP, 1135MP and 1115MP silicas from Rhodia, the Hi-Sil EZ150G silica from PPG, the Zeopol 8715, 8745 and 8755 silicas from Huber, treated precipitated silicas, such as, for example, the silicas “doped” with aluminium described in Application EP-A-0735088, or the silicas with a high specific surface as described in Application WO 03/16837.

The silica preferably has a BET specific surface of between 45 and 400 m²/g, more preferably of between 60 and 300 m²/g.

A person skilled in the art will understand that, as filler equivalent to silica described in the present section, use might be made of a reinforcing filler of another nature, in particular organic nature, provided that this reinforcing filler is covered with a layer of silica or else comprises functional sites, in particular hydroxyl sites, at its surface which require the use of a coupling agent in order to form the bond between the filler and the elastomer.

The fraction by volume of reinforcing filler in the rubber composition is defined as being the ratio of the volume of the reinforcing filler to the volume of all the constituents of the composition, it being understood that the volume of all the constituents is calculated by adding together the volumes of each of the constituents of the composition. The fraction by volume of reinforcing filler in a composition is thus defined as the ratio of the volume of the reinforcing filler to the sum of the volumes of each of the constituents of the composition and, preferably, this fraction by volume is between 5% and 20% and preferably between 5% and 15%. In an equivalent preferred way, the content of total reinforcing filler (carbon black and/or silica) is of less than 65 phr, preferably from 5 to 60 phr, more preferably from 10 to 50 phr and very preferably from 20 to 40 phr.

This is because an advantage of the invention is that of making it possible to reduce the content of reinforcing filler without loss in performance. Above a content of 65 phr, this advantage is no longer as great and the hysteresis of the composition increases.

Thus, preferably, the ratio of the content of filler to the content of zinc diacrylate derivative is within a range extending from 0.15 to 3 and preferably from 1.5 to 3. Alternatively and also preferably, the ratio of the content of filler to the content of zinc diacrylate derivative is within a range extending from 0.7 to 1.3.

Preferably, the composition of the internal layer of the tyre according to the invention predominantly comprises carbon black as reinforcing filler. Predominant reinforcing filler is understood to mean that which exhibits the greatest content among the reinforcing fillers present in the composition. Predominant reinforcing filler is understood in particular to mean any reinforcing filler which represents at least 50% by weight of the reinforcing fillers present, preferably more than 50% and more preferably more than 60%, indeed even more than 70%, indeed even more than 80%, indeed even more than 90%, indeed even 100%.

These compositions can also optionally contain, in addition to the reinforcing fillers and in particular when silica is used in the composition of the internal layer of the tyre according to the invention, coupling agents, coupling activators, agents for covering the inorganic fillers or more generally processing aids capable, in a known way, by virtue of an improvement in the dispersion of the filler in the rubber matrix and of a lowering of the viscosity of the compositions, of improving their ability to be processed in the raw state, these agents being, for example, hydrolysable silanes, such as alkylalkoxysilanes, polyols, fatty acids, polyethers, primary, secondary or tertiary amines, or hydroxylated or hydrolysable polyorganosiloxanes.

Use is made in particular, as coupling agent, of silane polysulphides, referred to as “symmetrical” or “asymmetrical” depending on their specific structure, such as described, for example, in Applications WO 03/002648 (or US 2005/016651) and WO 03/002649 (or US 2005/016650).

Suitable in particular, without the definition below being limiting, are silane polysulphides referred to as “symmetrical”, corresponding to the following general formula (III):

Z-A-Sₓ-A-Z, wherein: (III)
x is an integer from 2 to 8 (preferably from 2 to 5);
A is a divalent hydrocarbon radical (preferably C₁-C₁₈ alkylene groups or C₆-C₁₂ arylene groups, more particularly C₁-C₁₀, in particular C₁-C₄, alkylenes, especially propylene);
Z corresponds to one of the formulae below:

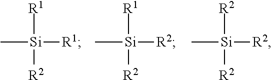

wherein:
the R¹ radicals, which are substituted or unsubstituted and identical to or different from one another, represent a C₁-C₁₈ alkyl, C₅-C₁₈ cycloalkyl or C₆-C₁₈ aryl group (preferably C₁-C₆ alkyl, cyclohexyl or phenyl groups, in particular C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

In the case of a mixture of alkoxysilane polysulphides corresponding to the above formula (II), in particular normal commercially available mixtures, the mean value of the “x” indices is a fractional number preferably of between 2 and 5, more preferably of approximately 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl) polysulphides (in particular disulphides, trisulphides or tetrasulphides), such as, for example, bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, of formula [(C₂H₅O)₃Si(CH₂)₃S₂]₂, or bis(3-triethoxysilylpropyl) disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl) polysulphides (in particular disulphides, trisulphides or tetrasulphides), more particularly bis(monoethoxydimethylsilylpropyl) tetrasulphide, such as described in Patent Application WO 02/083782 (or US 2004/132880).

Mention will also be made, as coupling agent other than an alkoxysilane polysulphide, of bifunctional POSs (polyorganosiloxanes) or else of hydroxysilane polysulphides (R²=OH in the above formula III), such as described in Patent Applications WO 02/30939 (or U.S. Pat. No. 6,774,255) and WO 02/31041 (or US 2004/051210), or else of silanes or POSs bearing azodicarbonyl functional groups, such as described, for example, in Patent Applications WO 2006/125532, WO 2006/125533 and WO 2006/125534.

In the rubber compositions of use in the invention, the content of coupling agent is preferably between 2 and 15 phr, more preferably between 3 and 13 phr and more preferably still between 5 and 10 phr.

### I-5 Vulcanization System

The composition of the internal layer of the tyre according to the invention does not require a vulcanization system, which is one of its advantages since this makes it possible to simplify the formulation, and the preparation of the composition. If, however, a vulcanization system is present in the composition, it is preferably present in small amounts explained below.

The vulcanization system proper is generally based on sulphur (or on a sulphur-donating agent) and on a primary vulcanization accelerator. Additional to this base vulcanization system are various known secondary vulcanization accelerators or vulcanization activators, such as zinc oxide, stearic acid or equivalent compounds, or guanidine derivatives (in particular diphenylguanidine), incorporated during the first non-productive phase and/or during the productive phase, as described subsequently.

Molecular sulphur (or equivalently agents which donate molecular sulphur), when it is used, is used at a content preferentially of less than 0.5 phr, preferably of less than 0.3 phr and more preferably at a content of less than 0.1 phr. Very preferably, the composition is devoid of molecular sulphur.

The vulcanization system of the composition according to the invention can also comprise one or more additional accelerators, for example compounds of the family of the thiurams, zinc dithiocarbamate derivatives, sulphenamides, guanidines or thiophosphates. Use may in particular be made of any compound capable of acting as accelerator for the vulcanization of diene elastomers in the presence of sulphur, in particular accelerators of the thiazole type, and also their derivatives, and accelerators of thiuram and zinc dithiocarbamate type. These accelerators are more preferably selected from the group consisting of 2-mercaptobenzothiazyl disulphide (abbreviated to MBTS), N-cyclohexyl-2-benzothiazolesulphenamide (abbreviated to CBS), N,N-dicyclohexyl-2-benzothiazolesulphenamide (abbreviated to DCBS), N-(tert-butyl)-2-benzothiazolesulphenamide (abbreviated to TBBS), N-(tert-butyl)-2-benzothiazolesulphenimide (abbreviated to TBSI), zinc dibenzyldithiocarbamate (abbreviated to ZBEC) and the mixtures of these compounds. Preferably, use is made of a primary accelerator of the sulphenamide type.

If an accelerator is used, it is used at contents such as those used by a person skilled in the art of vulcanized compositions for tyres. Nevertheless, the composition of the internal layer of the tyre according to the invention is preferably devoid of any vulcanization accelerator.

### I-6 Other Possible Additives

The internal layer compositions of the tyres in accordance with the invention optionally also comprise all or a portion of the normal additives generally used in elastomer compositions intended in particular for the manufacture of internal layers, such as, for example, pigments, protective agents, such as antiozone waxes, chemical antiozonants or antioxidants, plasticizing agents, such as those provided below, anti-fatigue agents, reinforcing resins, or methylene acceptors (for example novolak phenolic resin) or donors (for example HMT or H3M).

According to a preferred form, the composition of the internal layer of the tyre of the invention is devoid of antioxidant.

According to a preferred form, the composition of the internal layer of the tyre of the invention is devoid of plasticizing agent. Alternatively and according to an also preferred embodiment, the composition according to the invention additionally comprises a plasticizing agent. Preferably, this plasticizing agent is a solid hydrocarbon resin (or plasticizing resin), an extending oil (or plasticizing oil) or a mixture of the two.

It is obvious that the invention relates to the tyres provided with the internal layers comprising the rubber compositions described above, both in the “raw” or non-crosslinked state (i.e., before curing) and in the “cured” or crosslinked, or else vulcanized, state (i.e., after crosslinking or vulcanization).

### II—Preparation of the Rubber Compositions

The compositions are manufactured in appropriate mixers, using two successive phases of preparation which are well known to a person skilled in the art: a first phase of thermomechanical working or kneading (sometimes referred to as “non-productive” phase) at high temperature, up to a maximum temperature of between 110° C. and 190° C., preferably between 130° C. and 180° C., followed by a second phase of mechanical working (sometimes referred to as “productive” phase) at lower temperature, typically below 110° C., for example between 60° C. and 100° C., during which finishing phase the crosslinking or vulcanization system and in particular the peroxide of the compositions according to the invention is incorporated; such phases have been described, for example, in Applications EP-A-0 501 227, EP-A-0 735 088, EP-A-0 810 258, WO00/05300 or WO00/05301.

The first (non-productive) phase is preferably carried out in several thermomechanical stages. During a first stage, the elastomers and the reinforcing fillers (and optionally the coupling agents and/or other ingredients) are introduced into an appropriate mixer, such as an ordinary internal mixer, at a temperature of between 20° C. and 100° C. and preferably between 25° C. and 100° C. After a few minutes, preferably from 0.5 to 2 min, and a rise in the temperature to 90° C. to 100° C., the other ingredients (that is to say, those which remain, if not all were added at the start) are added all at once or in portions, with the exception of the crosslinking system and in particular of the peroxide, during a mixing ranging from 20 seconds to a few minutes. The total duration of the kneading, in this non-productive phase, is preferably between 2 and 10 minutes at a temperature of less than or equal to 180° C. and preferably of less than or equal to 170° C.

After cooling the mixture thus obtained, the crosslinking system and in particular the peroxide is then incorporated at low temperature (typically less than 100° C.), generally in an external mixer, such as an open mill; the combined mixture is then mixed (productive phase) for a few minutes, for example between 5 and 15 min.

The final composition thus obtained is subsequently calendered, for example in the form of a sheet or of a plaque, in particular for laboratory characterization, or else extruded, in order to form, for example, a rubber profiled element used in the manufacture of semi-finished products, in order to obtain products known as “internal layers”, such as carcass ply, crown plies (or tyre belt) or bead-wire filling. These products can subsequently be used in the manufacture of tyres, according to the techniques known to a person skilled in the art.

The vulcanization (or curing) is carried out in a known way at a temperature generally of between 130° C. and 200° C., under pressure, for a sufficient time which can vary, for example, between 5 and 90 min, as a function in particular of the curing temperature, of the vulcanization system adopted, of the kinetics of vulcanization of the composition under consideration or else of the size of the tyre.

The examples which follow illustrate the invention without, however, limiting it.

### III—Exemplary Embodiments of the Invention

### III-1 Preparation of the Examples

In the examples which follow, the rubber compositions were produced as described above.

### III-2 Characterization of the Examples

In the examples, the rubber compositions are characterized, before and/or after curing, as indicated below.

Dynamic Properties (after Curing): Tensile Test

These tensile tests make it possible to determine the elasticity stresses and the properties at break. Unless otherwise indicated, they are carried out in accordance with French Standard NF T 46-002 of September 1988. Processing the tensile recordings also makes it possible to plot the curve of modulus as a function of the elongation, the modulus used here being the nominal (or apparent) secant modulus measured in first elongation, calculated by reducing to the initial cross section of the test specimen. The nominal secant moduli (or apparent stresses, in MPa) are measured in first elongation at 50%, 100% and 300% elongation, respectively denoted M50, M100 and M300.

The breaking stresses (in MPa) and the elongations at break (EB in %) are also measured, at 23° C.±2° C., according to Standard NF T 46-002. The results are expressed “in base 100”, that is to say with respect to the control, to which a value of 100 is assigned.

All these tensile measurements are carried out under the standard conditions of temperature (23±2° C.) and hygrometry (50±5% relative humidity), according to French Standard NF T 40-101 (December 1979).

The dynamic properties G*(10%) and tan(δ)max at 60° C. are measured on a viscosity analyser (Metravib VA4000), according to Standard ASTM D 5992-96. The response of a sample of vulcanized composition (cylindrical test specimen with a thickness of 4 mm and a cross section of 400 mm²), subjected to a simple alternating sinusoidal shear stress, at a frequency of 10 Hz, under the defined conditions of temperature, for example at 60° C., according to Standard ASTM D 1349-99 or, as the case may be, at a different temperature, is recorded. A strain amplitude sweep is carried out from 0.1% to 50% (outward cycle) and then from 50% to 1% (return cycle). The results made use of are the complex dynamic shear modulus G* and the loss factor tan(δ). The maximum value of tan(δ) observed, denoted tan(δ)max, and the complex dynamic shear modulus G*(10%) at 10% strain, at 60° C., are shown for the return cycle.

It should be remembered that, in a way well-known to a person skilled in the art, the value of tan(δ)max at 60° C. is representative of the hysteresis of the material and thus of the rolling resistance: the lower tan(δ)max is at 60° C., the more the rolling resistance is reduced.

The same dynamic properties can be measured after having subjected the composition to thermal and thermal/oxidizing ageing. Interest is directed in particular at the elongation at break and at the M100 after ageing in order to study the impact of the ageing on the compositions. For this, the samples of composition are aged under the conditions described below and then the properties are measured.
Thermal ageing: 110° C. under nitrogen for 15 days on a plaque with a thickness of 2.5 mm.
Thermal/oxidizing ageing: 77° C. under air for 15 days on a plaque with a thickness of 2.5 mm.

### III-3 Examples

### Example 1

The object of this example is to compare the different rubber properties of control compositions with compositions in accordance with the invention. The compositions tested are presented in Table 1 below.

TABLE 1

| | C1 | C2 | C3 | I1 | I2 | I3 | I4 |
|---|---|---|---|---|---|---|---|
| NR (1) | 100 | 100 | 100 | 100 | 100 | 100 | 100 |
| ZDA derivative (2) | 20 | 20 | 20 | 20 | 20 | 20 | 20 |
| Peroxide (3) | 3.5 | 3 | 2 | 1.5 | 1.5 | 1 | 0.75 |
| Peroxide/ZDA derivative | 0.175 | 0.15 | 0.1 | 0.075 | 0.075 | 0.05 | 0.037 |
| Filler (4) | 3 | 3 | 3 | 3 | 20 | 3 | 3 |
| Filler/ZDA derivative | 0.15 | 0.15 | 0.15 | 0.15 | 1 | 0.15 | 0.15 |
| ZnO (5) | 6 | 6 | 6 | 6 | 6 | 6 | 6 |

(1) Natural rubber
(2) Zinc dimethylacrylate (ZDMA), Dimalink 634 from Cray Valley
(3) Dicumyl peroxide, Dicup from Hercules
(4) Carbon black, ASTM grade N326 (Cabot)
(5) Zinc oxide (industrial grade - Umicore)

The properties measured for the different compositions are given in Table 2 below.

TABLE 2

| | C1 | C2 | C3 | I1 | I2 | I3 | I4 |
|---|---|---|---|---|---|---|---|
| EB (base 100) | 25 | 53 | 100 | 135 | 132 | 150 | 175 |

In comparison with the control compositions, it is noted that the compositions I1, I2 and I3 exhibit a greatly improved elongation at break.

### Example 2

The object of this example is to compare the different rubber properties of a conventional control composition as internal mixture with compositions in accordance with the invention, before and after ageing. The compositions tested are presented in Table 3 below. The properties measured for the different compositions are given in Table 4 below.

In comparison with the control compositions, it is noted that the compositions I1, I2 and I5 exhibit properties after ageing which are markedly better than those of the control composition C1.

TABLE 3

| | C4 | I1 | I2 | I5 |
|---|---|---|---|---|
| NR (1) | 100 | 100 | 100 | 100 |
| ZDA derivative (2) | — | 20 | 20 | 20 |
| Peroxide (3) | — | 1.5 | 1.5 | 1.5 |
| Peroxide/ZDA derivative | — | 0.075 | 0.075 | 0.075 |
| Filler (4) | 50 | 3 | 20 | 40 |
| Filler/ZDA derivative | — | 0.15 | 1 | 2 |
| ZnO (5) | 6 | 6 | 6 | 6 |
| Stearic acid (6) | 0.6 | — | — | — |
| Antioxidant (7) | 2 | — | — | — |
| Sulphur | 5 | — | — | — |
| Accelerator (8) | 1 | — | — | — |

(1) Natural rubber
(2) Zinc dimethylacrylate (ZDMA), Dimalink 634 from Cray Valley
(3) Dicumyl peroxide. Dicup from Hercules
(4) Carbon black, ASTM grade N326 (Cabot)
(5) Zinc oxide (industrial grade - Umicore)
(6) Stearin. Pristerene 4931 from Uniqema
(7) N-(1,3-Dimethylbutyl)-N′-phenyl-p-phenylenediamine. Santoflex 6-PPD from Flexsys
(8) N.N-Dicyclohexyl-2-benzothiazolesulphenamide. Santocure DCBS from Flexsys

TABLE 4
Thermal/oxidizing ageing 15 days at 77° C.

| | C1 | I1 | I2 | I5 |
|---|---|---|---|---|
| M100 (base 100) before ageing | 100 | 70 | 100 | 140 |
| M100 (base 100) after ageing | 200 | 75 | 103 | 143 |
| EB (base 100) before ageing | 100 | 110 | 85 | 65 |
| EB (base 100) after ageing | 45 | 100 | 80 | 62 |
| Tg(δ)max at 60° C. before ageing | 100 | 20 | 35 | 60 |
| Tg(δ)max at 60° C. after ageing | 130 | 22 | 37 | 65 |

TABLE 5
Thermal ageing 15 days at 110° c.

| | C1 | I1 | I2 | I5 |
|---|---|---|---|---|
| M100 (base 100) before ageing | 100 | 70 | 100 | 140 |
| M100 (base 100) after ageing | 85 | 70 | 85 | 115 |
| AR (base 100) before ageing | 100 | 110 | 85 | 65 |
| AR (base 100) after ageing | 60 | 85 | 100 | 85 |

Results shown in Tables 4 and 5 demonstrate that the mechanical properties of compositions in accordance with the invention evolve only very slightly after aging. These compositions also retain the very gain in hysteresis.

1.-22. (canceled)

23. A tire provided with an internal layer, said internal layer comprising a rubber composition based on at least one diene elastomer, a peroxide, and a zinc diacrylate derivative in the form of a zinc salt of formula (I): 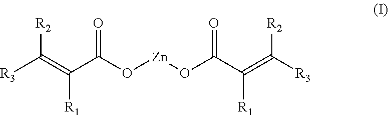
wherein R₁, R₂ and R₃ independently represent a hydrogen atom or a C₁-C₇ hydrocarbon group selected from linear, branched or cyclic alkyl groups, aralkyl groups, alkylaryl groups and aryl groups and optionally interrupted by one or more heteroatoms, it being possible for R₂ and R₃ to together form a nonaromatic ring,
wherein the contents of zinc diacrylate derivative and of peroxide are such that the ratio of the content of peroxide to the content of zinc diacrylate derivative is less than or equal to 0.09,
wherein the rubber composition does not comprise a reinforcing filler or further comprises less than 65 phr of a reinforcing filler, the ratio of the content of reinforcing filler, if present, to the content of zinc diacrylate derivative being less than or equal to 4, and
wherein, if present, the reinforcing filler is predominantly composed of carbon black.

24. The tire according to claim 23, wherein R₁, R₂ and R₃ independently represent a hydrogen atom or a methyl group.

25. The tire according to claim 23, wherein R₂ and R₃ each represent a hydrogen atom.

26. The tire according to claim 23, wherein R₁ represents a methyl group.

27. The tire according to claim 23, wherein the amount of zinc diacrylate derivative in the composition is within a range extending from 5 to 40 phr (parts by weight per hundred parts by weight of elastomer).

28. The tire according to claim 27, wherein the amount of zinc diacrylate derivative in the composition is within a range extending from 7 to 35 phr.

29. The tire according to claim 23, wherein the peroxide is an organic peroxide.

30. The tire according to claim 23, wherein the amount of peroxide is less than or equal to 3 phr.

31. The tire according to claim 30, wherein the amount of peroxide is within a range extending from 0.1 to 3 phr.

32. The tire according to claim 31, wherein the amount of peroxide is within a range extending from 0.2 to 2.5 phr.

33. The tire according to claim 32, wherein the amount of peroxide is within a range extending from 0.25 to 1.8 phr.

34. The tire according to claim 23, wherein the ratio of the content of peroxide to the content of zinc diacrylate derivative is between 0.01 and 0.09.

35. The tire according to claim 34, wherein the ratio of the content of peroxide to the content of zinc diacrylate derivative is between 0.03 and 0.09.

36. The tire according to claim 35, wherein the ratio of the content of peroxide to the content of zinc diacrylate derivative is between 0.05 and 0.08.

37. The tire according to claim 23, wherein the diene elastomer is selected from the group consisting of polybutadienes, synthetic polyisoprenes, natural rubber, butadiene copolymers, isoprene copolymers and mixtures thereof.

38. The tire according to claim 37, wherein the diene elastomer is selected from the group consisting of isoprene elastomers.

39. The tire according to claim 37, wherein the diene elastomer is selected from the group consisting of natural rubber, synthetic polyisoprenes, isoprene copolymers and mixtures thereof.

40. The tire according to claim 39, wherein reinforcing filler is present at a content within a range extending from 5 to 60 phr.

41. The tire according to claim 40, wherein the content of reinforcing filler is within a range extending from 10 to 50 phr.

42. The tire according to claim 41, wherein the content of reinforcing filler is within a range extending from 20 to 40 phr.

43. The tire according to claim 23, wherein reinforcing filler is present and additionally comprises silica.

44. The tire according to claim 23, wherein the ratio of the content of reinforcing filler to the content of zinc diacrylate derivative is within a range extending from 0.15 to 3.

45. The tire according to claim 44, wherein the ratio of the content of reinforcing filler to the content of zinc diacrylate derivative is within a range extending, preferably from 1.5 to 3.

46. The tire according to claim 23, wherein the rubber composition does not contain molecular sulphur or a sulphur-donating agent as a vulcanization agent or contains less than 0.5 phr of molecular sulphur or a sulphur-donating agent.

47. The tire according to claim 46, wherein the rubber composition contains less than 0.3 phr of molecular sulphur or a sulphur-donating agent.

48. The tire according to claim 47, wherein the rubber composition contains less than 0.1 phr of molecular sulphur or a sulphur-donating agent.

49. The tire according to claim 23, wherein the rubber composition does not contain a vulcanization accelerator.

50. The tire according to claim 23, wherein the rubber composition does not contain an antioxidant.

54. The tire according to claim 23, wherein the internal layer is selected from the group consisting of carcass plies, crown plies, bead-wire fillings, decoupling layers and combinations thereof.
